(19) United States
(12) Patent Application Publication
(10) Pub. No.: US 2007/0047725 A1
(43) Pub. Date: Mar. 1, 2007

(54) Taylor made mobile answering service

(76) Inventor: Taylor Christopher Carthern, Atlanta, GA (US)

Correspondence Address: Taylor Carthern, 110 Old Fairburn Close, Atlanta, GA, 30331, US

(21) Appl. No.: 11/212,210

(22) Filed: Aug. 27, 2005

(51) Int. Cl. H04M 11/00; H04M 1/00; H04M 3/00

(52) U.S. Cl. 379/373.02; 379/88.16

(57) ABSTRACT

This present invention relates to having a person makes a call you will hear a song or a movie clip or other audio, but instead of hearing the person's regular voicemail; you will hear whomever's song is playing or who is saying the clip, voice on the voicemail with his message telling you to leave a message for the person that you are calling for. You will be able to have many different songs associate with different callers on your phone. For Example, you will be able to have another song for your mother, a different song for your cousin, another for your girlfriend, and etc. Ex. Lets say I call someone's phone and instead of me hearing the phone ring, I hear 50 cents In the Club song. If the person does not pick up the phone, I will hear 50 cent's voice on the voicemail telling me to leave a message. You will call someone and instead of hearing the phone ring you will hear a song and when the voicemail answers whomever is singing the song being played answers the voicemail and say that the person receiving the call is unavailable and will say to leave a message.

### BACKGROUND-FIELD OF INVENTION

The technology of phones is steadily increasing. Phones are able to have ring tones that are fll mp3 songs and many other things. Now you can call someone and instead of hearing the phone ring you hear songs playing, until the person answers or it goes to there voicemail. There is something missing though. We will do the same thing when a person makes a call you will hear a song or a movie clip or other audio, but instead of hearing the person's regular voicemail; you will hear whomever's song is playing voice on the voicemail with his message telling you to leave a message for the person that you are calling for.

### OBJECTS AND ADVANTAGES

Several of the advantages of my invention include:
1. Our design will enhance the design and style of in call ring tones.
2. You will be able to have people listen to your favorite song when they call you and have your favorite celebrity or favorite artist answer your voicemail.

### SUMMARY OF INVENTION

This present invention relates to having a person makes a call you will hear a song or a movie clip or other audio, but instead of hearing the person's regular voicemail; you will hear whomever's song is playing or who is saying the clip, voice on the voicemail with his message telling you to leave a message for the person that you are calling for. You will be able to have many different songs associate with different callers on your phone. For Example, you will be able to have another song for your mother, a different song for your cousin, another for your girlfriend, and etc. Ex. Lets say I call someone's phone and instead of me hearing the phone ring, I hear 50 cents In the Club song. If the person does not pick up the phone, I will hear 50 cent's voice on the voicemail telling me to leave a message.

### BRIEF DESCRIPTION OF DRAWINGS

n/a

### DETAILED DESCRIPTIONS OF DRAWINGS

This present invention relates to having a person makes a call you will hear a song or a movie clip or other audio, but instead of hearing the person's regular voicemail; you will hear whomever's song is playing or who is saying the clip, voice on the voicemail with his message telling you to leave a message for the person that you are calling for. You will be able to have many different songs associate with different callers on your phone. For Example, you will be able to have another song for your mother, a different song for your cousin, another for your girlfriend, and etc. Ex. Lets say I call someone's phone and instead of me hearing the phone ring, I hear 50 cents In the Club song. If the person does not pick up the phone, I will hear 50 cent's voice on the voicemail telling me to leave a message. You may hear a sample of a message of T.D. Jakes preaching and he will answer your voicemail if the person does not answer the phone.

What I claim as my invention is:

1. A method of having a song, movie clip, speech or any audio being played when you call someone instead of them (the person calling) hearing the phone ring; and if the person's voicemail answers it will be the person from the movie clip or any audio saying that the person that you are trying to reach is unavailable and to leave a message.

2. The method of claim 1 where you are able to assign different songs and phone messages to different phone numbers in your phone and they will hear a different song and/or message based on who just called you.

3. The method of claim 1 where you can assign a primary song and phone message to your phone if the person who just called you is not in your phone or there number has not been assigned, and/or also have different people assigned to different messages.

4. The method claim 1 of having a person's song being played while you are calling someone and also hearing the same person that song the song answer that person's voicemail.

5. A method of having a song, movie clip, speech or any audio being played when you call someone instead of them (the person calling) hearing the phone ring; and if the person's voicemail answers it will be any artist/celebrity/minister/politician (not the one that you hear when the phone is ringing) saying that the person that you are trying to reach is unavailable and to leave a message.

6. The method claim 1 of having a person's speech being played while you are calling someone and also hearing the same person that spoke answer that person's voicemail.

7. The method claim 1 of having a person's movie clip being played while you are calling someone and also hearing the same person that is talking in the movie clip answer that person's voicemail.

8. The method claim 1 of having a person's sermon being played while you are calling someone and also hearing the same person said the sermon answer that person's voicemail.

9. The method claim 5 of having a person's speech being played while you are calling someone and also hearing another person answer that person's voicemail.

10. The method claim 5 of having a person's movie clip being played while you are calling someone and also hearing another person answer that person's voicemail.

11. The method claim 5 of having a person's sermon being played while you are calling someone and also hearing another person answer that person's voicemail.

12. The method claim 5 of having a commercial or television show clip being played while you are calling someone and also hearing another person answer that person's voicemail.

13. The method claim 1 of having a commercial or television show clip being played while you are calling someone and also hearing the same person from the commercial and/or television clip answer that person's voicemail.

14. The method claim 1 of having a cartoon character voice and/or show's song being played while you are calling someone and also hearing the cartoon character from the whose voice was heard answer that person's voicemail.

15. A method of having a song, movie clip, speech or any audio being played when you call someone instead of them (the person calling) hearing the phone ring; and if the person's voicemail answers it will be the person from the movie clip or any audio saying, rapping and/or singing that the person that you are trying to reach is unavailable and to leave a message.
